(19) United States
(12) Patent Application Publication
(10) Pub. No.: US 2011/0182689 A1
(43) Pub. Date: Jul. 28, 2011

(54) Blind Fastener System

(76) Inventor: Edward Avetisian, Burbank, CA (US)

(21) Appl. No.: 13/015,885

(22) Filed: Jan. 28, 2011

Related U.S. Application Data
(60) Provisional application No. 61/299,308, filed on Jan. 28, 2010.

(51) Int. Cl. F16B 13/04

(52) U.S. Cl. 411/22

(57) ABSTRACT

A fastener system attaches a structural member to a workpiece, the structural member and workpiece each having an aperture for insertion of the fastener system. The fastener system has a nut member having a threaded axial opening, a stud member having threads which mate with the threads of the nut member, and a collet member which is retained on the end of the stud member. The collet member has an unexpanded diameter smaller than the diameter of the aperture in the workpiece so the collet member may be inserted completely through the workpiece. Once on the opposite side of the workpiece, rotation of the stud member with respect to the nut member, achieved either by rotation of the stud member while preventing rotation of the nut member or vice-versa, causes the collet member to expand to a diameter larger than the diameter of the aperture in the workpiece. Further rotation of stud member with respect to the nut member increases the clamp-up load of the anchor, thus anchoring the structural member to the workpiece. Rotation of the stud member with respect to the nut member in the opposite direction causes the collet member to return to its unexpanded diameter, allowing removal of the collet member from the workpiece.

### CROSS-REFERENCE TO RELATED APPLICATIONS

U.S. Provisional Application No. 61/299,308 for this invention was filed on Jan. 28, 2010, for which application this inventor claims domestic priority.

### BACKGROUND OF THE INVENTION

The disclosed device relates generally to anchoring devices and fasteners which are utilized to attach a structural member to a workpiece, where the workpiece has a first side, for which access is available, and a second side, which may be a blind side where access is not available. It is to be understood that the term “workpiece” as used in this specification refers to any material for which it is desirable to use any of the disclosed embodiments of this device. Typically, but not necessarily, the materials for which such devices have the greatest utility are blind applications for thin walled materials such as sheet metal or laminated composite materials. In installations where there is only ready access to one side of a workpiece, it is necessary to employ anchors which may be completely deployed and installed on the visible side of the workpiece.

With the known anchors, the portion of the device positioned on the blind side of the workpiece is deformed in the installation process and may only be utilized a single time. Moreover, if the fastener is removed from the anchor, the deformed portion of the anchor on the blind side of the workpiece is not easily removed, if removeable at all.

### SUMMARY OF THE INVENTION

The disclosed apparatus is a blind fastener system in which the anchor may be removed from the blind side of the workpiece, and may be reused if desired. The apparatus comprises a collet member, a stud member, and a nut member. Upon rotation of the stud member, while simultaneously preventing rotation of the nut member, the expandable collet member is pulled upwardly into engaging contact with the blind side of the workpiece. Tightening of the stud member causes substantial expansion of the collet member to improve the clamp-up load of the anchor. Upon loosening of the stud member, the expandable collet member returns to its unexpanded condition, having a diameter small enough to be retracted from the opening in the workpiece.

The stud member comprises a threaded stud having a tool engagement end and a collet member stop end. The tool engagement end comprises means for engaging the stud member with a tool to either rotate the stud member or prevent rotation. For example, the tool engagement end of the stud member may comprise a broached opening having a hex profile for insertion of an allen wrench or hex head driver. The collet member stop end comprises means for retaining the collet member on the threaded stud. The collet member stop end may comprise a non-threaded section upon which a retainer ring may be pressed to retain the collet member from axial movement along the stud past the collet member stop end. Alternatively the collet member stop end may terminate with an integral shoulder for retaining the collet member. The non-threaded section may further comprise an outwardly protruding shoulder adjacent to the collet member stop end, wherein the outwardly protruding shoulder is engaged by inwardly facing pawls of the collet, thus preventing axial movement of the collet along the stud toward the tool engagement end, such that the collet member is retained at the same axial position along the stud member.

The collett member comprises a plurality of conjoined cantilevering arms, arranged in a cylindrical configuration, the collet member having a top end and a bottom end wherein, when assembled with the stud member, the bottom end abuts the collet member stop end. Each of the cantilevering arms may comprise, at the bottom end, an inwardly facing pawl which engages the outwardly protruding shoulder of the stud member. At the top end, each of the cantilevering arms may terminate with a externally facing shoulder which engages the facing surface of the blind side of the workpiece. It is to be appreciated that the terms “top” and “bottom” are used with respect to the respective position as shown in the figures included herein, and bear no relationship to the actual position of the components as actually installed.

The collet member has a plurality of slots which define the cantilevering arms, such that some of the cantilevering arms are fixed at the bottom end of the collet member while the adjacent cantilevering arms are fixed at the top end. If there are four slots which extend from the bottom end, those slots define four cantilevering arms at the bottom end. Likewise, if there are four slots which extend from the top end, those slots define four cantilevering arms at the top end.

The nut member has an opening extending axially through its entire length, the length defined between a head and a tip. This opening comprises threads which mate with the threads of the stud member. The nut member comprises a sleeve which depends from the head. Where the device is utilized to attach a structural member to a workpiece, the sleeve extends through an aperture in the structural member as well as through the aperture in the workpiece. The head may comprise a flared end which may seat into a countersunk portion of the aperture in the structural member. The head further comprises tool engagement means which allow a tool to grasp the nut member to prevent its rotation. For example, the tool engagement means may comprise a hex profile which may be engaged by a socket or wrench. In this embodiment, the head is typically protruding such that it protrudes above the structural member being attached to the workpiece. Alternatively, the nut member may comprise a flared head which is mounted flush within a counter bore placed in the aperture of the structural member. With the flared head embodiment, the tool engagement means may comprise openings in the top surface of the head which may be engaged by a spanner type tool or other device.

The sleeve has a section of gradually reducing external diameter in the form of a truncated cone as the sleeve extends axially toward the tip. As the stud member is rotated, with the nut member prevented from rotating, the collet member is pulled over this section of the sleeve, toward the portion having the larger diameter, such that the cantilevering arms are forced outwardly by the increasing diameter. Of course, the movement in the collet member may also achieved by rotating the nut member while preventing the stud member from rotating. As the collet member is pulled further over the increasing diameter of the sleeve, the cantilevering arms are forced outwardly, such that the externally facing shoulder of each cantilevering arm engages the surface of the blind side, until the stud member (or nut member) is tightened to the desired torque. If the stud member has normal threads, the collet member is pulled over the sleeve by rotating the stud member out of the nut member by left-hand rotation (i.e., backing the stud member out of the nut member).

If it becomes desirable to remove the anchor, the stud (or nut member) is rotated in the opposite direction to the direction utilized for setting the anchor, such that the collet member is disengaged from the sleeve. As the collet member is disengaged, the cantilevering arms return to their original configuration. It is to be appreciated that the collet member must be manufactured from materials having mechanical properties such that the cantilevering arms do not yield (i.e., not exceed the elastic limit) as the arms are subjected to the engagement-disengagement cycle with the sleeve.

### BRIEF DESCRIPTION OF THE DRAWINGS

FIG. 1 shows a perspective view of an embodiment of the disclosed blind fastener system with the nut member removed from the stud member.

FIG. 2 shows the blind fastener system of FIG. 1 with the nut member attached to the stud member.

FIGS. 3A and 3B show how the collet member is pulled against the bottom surface of the workpiece as the stud member is withdrawn from the nut member, with FIG. 3A showing the collet in an unexpanded condition and FIG. 3B showing the collet in an expanded condition.

FIGS. 4A and 4B show a top view and a partial side view of an embodiment of a nut-stud combination which may be utilized with the blind fastener system.

FIGS. 5A and 5B show a top view and a partial side view of an embodiment of a nut-stud combination which may be utilized with the blind fastener system.

FIGS. 6A and 6B show a top view and a partial side view of an embodiment of a nut-stud combination which may be utilized with the blind fastener system.

FIG. 7 shows an alternative embodiment of the blind fastener system in which a substructure insert is installed in the workpiece prior to installation of the blind fastener system.

FIG. 8 shows an alternative embodiment of the blind fastener system in which a different type of substructure insert than shown in FIG. 7 is installed in the workpiece prior to installation of the blind fastener system.

### DETAILED DESCRIPTION OF THE EMBODIMENTS

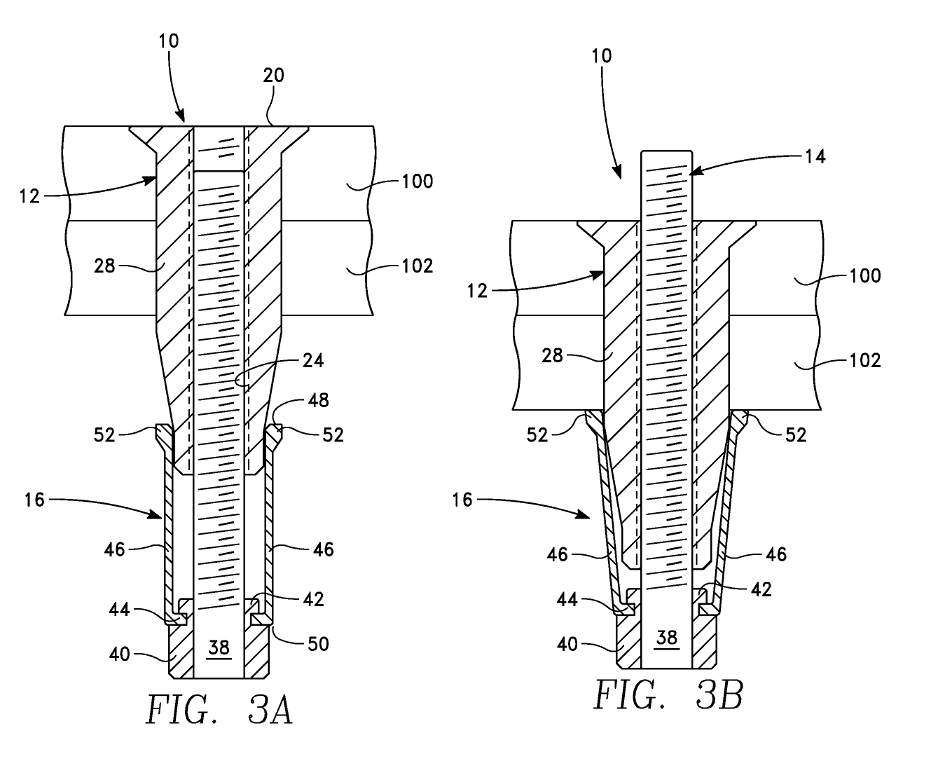

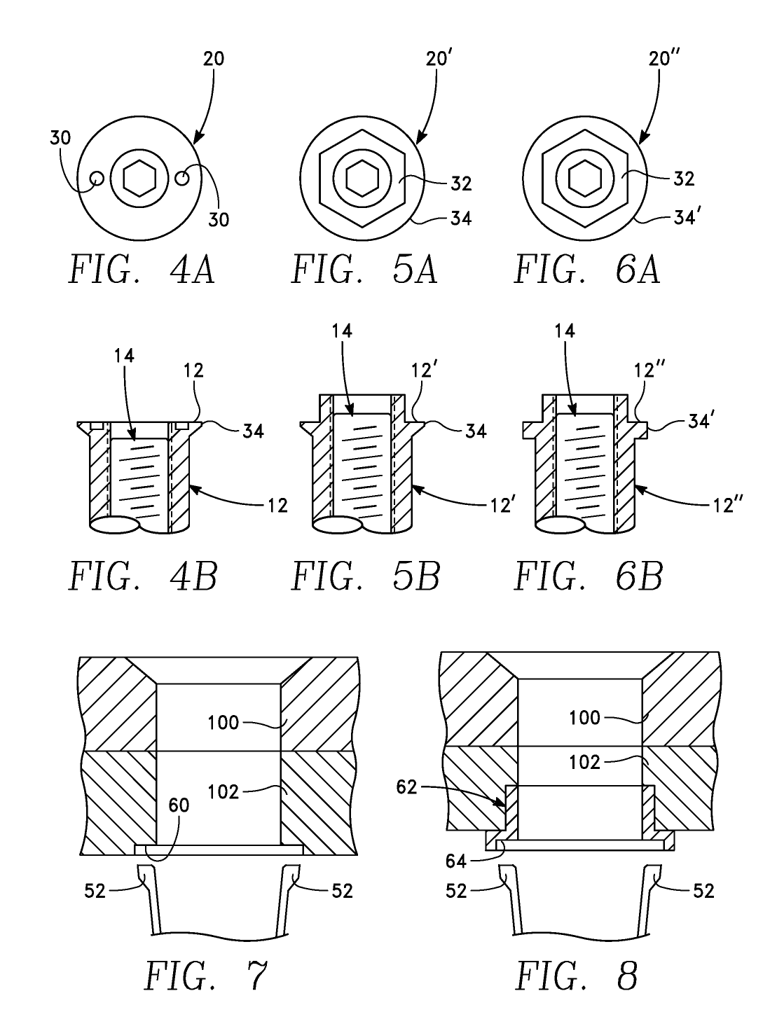

Referring now to the Figures, an embodiment of the disclosed fastener system 10 comprises a nut member 12, as stud member 14 and a collet member 16. The nut member 12 has an opening 18 extending axially through its entire length, where the length is defined between a head 20 and a tip 22. The opening 18 of nut member 12 comprises interior threads 24 which mate with the threads 26 of the stud member 14. The nut member 12 further comprises a sleeve member 28 which depends from the head 20. As shown in FIGS. 3A and 3B, when the disclosed fastener system 10 is utilized to attach a structural member 100 to a workpiece 102 , the sleeve 28 extends through an aperture in the structural member as well as through an aperture in the workpiece. The head 20 may comprise a flared end which may seat into a countersunk portion of the aperture in the structural member 100.

The head 20 further comprises tool engagement means which allow a tool to grasp the nut member to prevent its rotation. For example, the tool engagement means may comprise openings 30 in the top surface of the head 20 which may be engaged by a spanner type tool or other device. Alternatively, a nut member 12′ may comprise a head 20′ which comprises a hex profile 32 as shown in FIG. 5A and FIG. 5B, which may be engaged by a socket or wrench. In this embodiment, as shown in FIG. 5B, below the hex profile 32 the nut member 12′ has a flared shoulder 34 so that a portion of the head 20′ is mounted within a counter bore placed in the aperture of the structural member 100. Alternatively, as shown in FIG. 6A and 6B, the nut member 12″ may comprise a head 20″ having a hex profile 32, but having a square shoulder 34′ such that the head 20″ protrudes above the structural member 100 being attached to the workpiece 102.

Stud member 14 comprises threads 26 which match the interior threads 24 of nut member 12. Stud member 14 has a tool engagement end 36 and a collet member stop end 38. The tool engagement end 36 comprises means for engaging the stud member 14 with a tool to either rotate the stud member or prevent rotation. For example, the tool engagement end 36 of the stud member 14 may comprise a broached opening 38 having a hex profile for insertion of an allen wrench or hex head driver. The collet member stop end 38 comprises means for retaining the collet member 16 on the stud member 14. The collet member stop end 38 may comprise a non-threaded section upon which a retainer ring 40 may be pressed to retain the collet member 16 from axial movement along the stud member 14 past the collet member stop end. Alternatively the collet member stop end 14 may terminate with an integral shoulder as opposed to ring 40 for retaining the collet member 16 on the stud member 14. The retainer ring 40, or non-threaded section of the stud member 14, may further comprise an outwardly protruding shoulder 42 adjacent to the collet member stop end 38, wherein the outwardly protruding shoulder is engaged by inwardly facing pawls 44 of the collet member 16, thus preventing axial movement of the collet member along the stud member 14 toward the tool engagement end 36, such that the collet member is retained at the same axial position along the stud member.

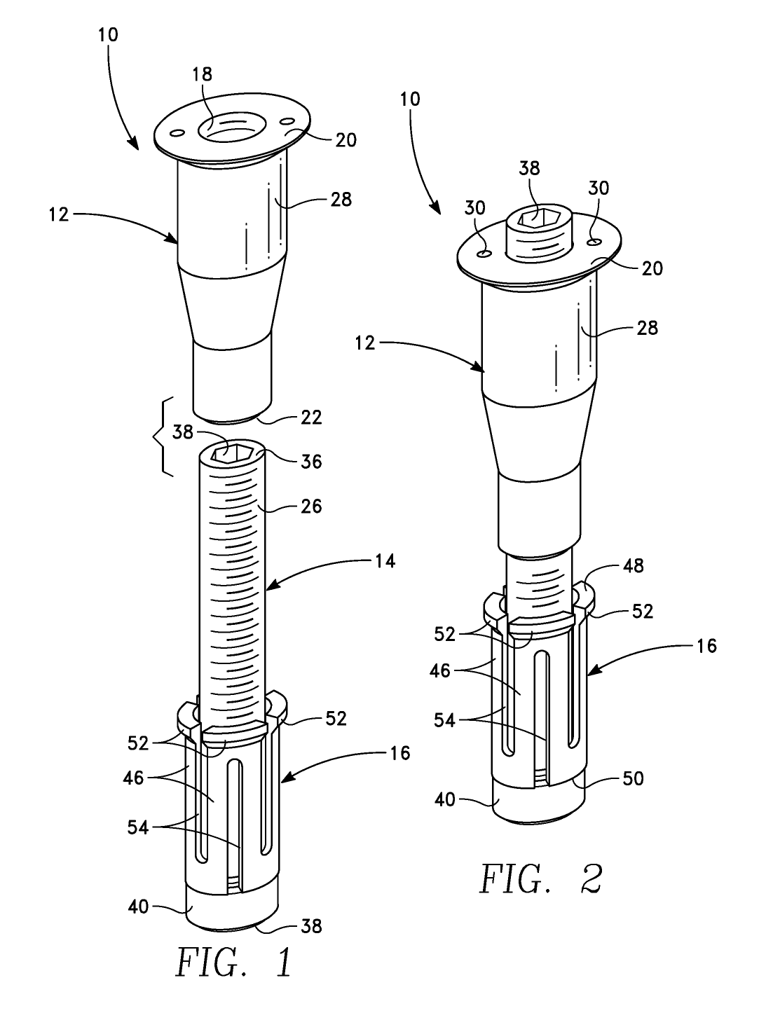

Collett member 16 comprises a plurality of conjoined cantilevering arms 46. As shown best in FIGS. 1-2, the cantilevering arms 46 are arranged in a cylindrical configuration. Collet member has a top 48 and a bottom 50. When assembled with the stud member 14, the bottom 50 abuts the retainer ring 40 at collet member stop end 38. Each of the cantilevering arms 46 may comprise, at the bottom, an inwardly facing pawl 44 which engages the outwardly protruding shoulder 42 of the retainer ring 40 or integral shoulders on stud member 14. At the top 48, each of the cantilevering arms 46 may terminate with a externally facing shoulder 52 which, when the fastener system is fully engaged, engages the facing surface of the blind side of the workpiece 102 as shown in FIG. 3B.

The collet member 16 has a plurality of slots 54 which define the cantilevering arms 46, such that some of the cantilevering arms are fixed at the top 48 of the collet member while the adjacent cantilevering arms are fixed at the bottom 50. If there are four slots 54 which extend from the top 48, those slots define four cantilevering arms at the top. Likewise, if there are four slots 54 which extend from the bottom 50, those slots define four cantilevering arms 46 at the bottom 50 of the collet member 16. This structure, along with the material construction of the collet member which will not exceed the elastic limit of the material as the fastener is fully engaged (i.e., the collet member is fully expanded) provides the necessary flexibility for the collet member 16 to return to its original diameter (i.e., its unexpanded diameter) when the stud member 14 is loosened with respect to the nut member 12. Acceptable materials for all components of the disclosed fastener system may comprise various metal alloys including alloy steel, stainless or corrosion resistant steel, aluminum alloys, titanium and other materials having the required physical and chemical properties for the particular application.

As shown in FIG. 1 and FIG. 2, sleeve 28 of the nut member 12 transitions from a first diameter adjacent to the head 20 to a second smaller diameter adjacent to the tip 22, with a section of gradually reducing external diameters in the configuration of a truncated cone as the sleeve extends axially toward the tip 22, As the stud member 14 is rotated, with the nut member prevented from rotating, the collet member 16 is pulled over the section of the sleeve 28 having the truncated conical exterior, such that the cantilevering arms 46 are forced outwardly by the increasing diameter of the sleeve, as illustrated in FIGS. 3A and 3B. Of course, the movement in the collet member 16 may also achieved by rotating the nut member 12 while preventing the stud member 14 from rotating. As the collet member 16 is pulled further over the increasing diameter of the sleeve 28, forcing the cantilevering arms 46 outwardly, externally facing shoulders 52 of the cantilevering arms may engage the surface of the blind side of the workpiece 102, until the stud member 14 (or nut member 12) is tightened to the desired torque. If the stud member 14 has normal threads 26, the collet member 16 is pulled over the sleeve 28 by rotating the stud member out of the nut member 12 by left-hand rotation (i.e., backing the stud member out).

The rotation of the stud member 14, while simultaneously preventing rotation of the nut member 12, pulls the expandable collet member 16 into engaging contact with the blind side of the workpiece 102. Further rotation of the stud member 14 causes substantial expansion of the collet member 16 to improve the clamp-up load of the anchor, such that the collet member achieves an expanded diameter. Upon rotation of the stud member 14 in the opposite direction, the expandable collet member 16 returns to its unexpanded condition, such that the collet member is disengaged from the larger diameter section of sleeve 28. As the collet member 16 is disengaged from sleeve 28, the cantilevering arms 46 return to their original relaxed unexpanded configuration, such that the entire collet member may be retrieved from the workpiece 102. It is to be appreciated that the collet member 16 must be manufactured from materials having mechanical properties such that the cantilevering arms 46 do not yield (i.e., not exceed the elastic limit) as the arms are subjected to the engagement-disengagement cycle with the sleeve 28.

FIG. 7 shows a panel preparation for an embodiment of the disclosed blind fastener system 10. In this embodiment, a retainer insert 60 is pressed fit and bonded into the aperture of workpiece 102 prior to installation of the components of the fastener system 10. As shown schematically in FIG. 7, retainer insert 60 is engaged by the externally facing shoulder 52 of each cantilevering arm 46, thus preventing direct contact between the substructure of the workpiece and the collet member 16. FIG. 8 shows another embodiment of retainer insert 62 which may be press fit and bonded into the aperture of the workpiece 102. As shown in FIG. 8, this retainer insert 62 lines a substantial portion of the aperture of the workpiece, and also has a receiving socket 64 defined by a peripheral wall which guides the externally facing shoulders 52 of the cantilevering arms 46.

While the above is a description of various embodiments of the present invention, further modifications may be employed without departing from the spirit and scope of the present invention. Thus the scope of the invention should not be limited by the specific structures disclosed. Instead the true scope of the invention should be determined by the following claims.

What is claimed is:

1. A fastener system for attaching a structural member to a workpiece, the structural member and workpiece each having an aperture there through, the apertures in axial alignment, the structural member having a top surface and the workpiece having a bottom surface, the fastener system comprising:
a nut member having a head and a sleeve member depending from the head, the sleeve member terminating in a tip, the sleeve member comprising an intermediate section comprising a truncated conical exterior;
an axial opening extending from the head to the tip, at least a portion of the axial opening comprising threads;
a stud member comprising threads which mate with the threads of the axial opening of the nut member, the stud member further comprising a tool engagement end and a collet member stop end; and
a collet member having a top and a bottom, the collet member comprising a plurality of cantilevering arms arranged in a cylindrical configuration about an axial opening extending from the top to the bottom through which a portion of the stud member is disposed, the collet member retained on the stud member by collet member stop means at the collet member stop end wherein the top of the collet member is brought into engaging contact with the bottom surface of the workpiece by rotation of the stud member with respect to the nut member and the cantilevering arms are deflected outwardly as the collet member engages the truncated conical exterior, without exceeding the elastic limit of the cantilevering arms.

2. The fastener system of claim 1 wherein the head comprises tool engagement means.

3. The fastener system of claim 2 wherein the head comprises a top surface and the tool engagement means comprises an opening in the top surface adaptable for receiving a tool head.

4. The fastener system of claim 1 wherein the head comprises a hexagonal profile.

5. The fastener system of claim 1 wherein the head comprises a flared end.

6. The fastener system of claim 1 wherein the collet member stop means comprises a retainer ring attached to the collet member stop end of the stud member.

7. The fastener system of claim 1 wherein the cantilevering arms comprise an inwardly facing pawl member at the bottom.

8. The fastener system of claim 1 wherein one or more of the cantilevering arms comprise an externally facing shoulder at the top.

9. The fastener system of claim 1 wherein the tool engagement end comprises a broached hex opening.

10. The collet member of claim 1 wherein the cantilevering arms are each separated by an axially-aligned slot.

11. The collet member of claim 1 wherein each cantilevering arm comprises an axially-aligned slot extending to the bottom of the collet member.

12. The fastener system of claim 1 further comprising a retainer insert pressed into the aperture at the bottom surface of the workpiece.

13. The fastener system of claim 8 further comprising a retainer insert pressed into the aperture at the bottom surface of the workpiece wherein the retainer insert comprises a receiving socket for the externally facing shoulders of the cantilevering arms.

14. A fastener system for attaching a structural member to a workpiece, the structural member and workpiece each having an aperture there through, the apertures in axial alignment and the aperture in the workpiece having a first diameter, the fastener system comprising:
a nut member comprising an axial opening extending through the nut member, the axial opening comprising threads;
a stud member having exterior threads which mate with the threads of the threads of the axial opening, the stud member further comprising a tool engagement end and a collet member stop end opposite the tool engagement end; and
a collet member disposed at the collet member stop end, the collet member having an unexpanded diameter smaller than the first diameter, the collet member expandable to an expanded diameter larger than the first diameter upon rotation of the stud member with respect to the nut member in a first direction, the collet member returning to the unexpanded diameter upon rotation of the stud member with respect to the nut member in a second direction opposite from the first direction.

15. The fastener system of claim 14 wherein the nut member comprises a head.

16. The fastener system of claim 15 wherein the head comprises tool engagement means.

17. The fastener system of claim 16 wherein the head comprises a top surface and the tool engagement means comprises an opening in the top surface adaptable for receiving a tool head.

18. The fastener system of claim 15 wherein the head has a hexagonal profile.

19. The fastener system of claim 15 wherein the head comprises a flared end.

20. The fastener system of claim 14 wherein the collet member stop means comprises a retainer ring attached to the collet member stop end of the stud member.
